(19) United States
(12) Patent Application Publication
(10) Pub. No.: US 2020/0246212 A1
(43) Pub. Date: Aug. 6, 2020

(54) WEARABLE ELECTRONIC DEVICE, DISPLAY DEVICE, AND CONTROL METHOD THEREFOR

(71) Applicant: SAMSUNG ELECTRONICS CO., LTD., Suwon-si (KR)

(72) Inventors: Min-gu LEE, Hwaseong-si (KR); Seoung-hun KIM, Hwaseong-si (KR)

(73) Assignee: SAMSUNG ELECTRONICS CO., LTD., Suwon-si (KR)

(21) Appl. No.: 15/774,492

(22) PCT Filed: Aug. 18, 2016
(86) PCT No.: PCT/KR2016/009120

§ 371 Date: May 8, 2018

(30) Foreign Application Priority Data
Nov. 11, 2015 (KR) 10-2015-0158253

(51) Int. Cl. A61H 9/00

(52) U.S. Cl. CPC A61H 9/0021; A43B 3/0005

(57) ABSTRACT

The present invention relates to an electronic device to be worn on a user body, the electronic device comprising: a sensor configured to sense the user body and generate body condition information; an operation implementator configured to perform a health care operation having one state among a plurality of operation states; a communicator configured to communicate with an external device; and a controller configured to: control the operation implementator to perform a health care operation of one state among the plurality of operation states with regard to the user body, control the communicator to transmit the body condition information and information about the operation state of the operation implementator to the external device, and control the operation implementator to perform the health care operation of the operation state corresponding to user control information received from the external device through the communicator among the plurality of operation states of the operation implementator. Thus, it is possible to be worn on a user's body and sense the user's body, transmit the sensed information, and provide a health care operation to a user in response to the received user control information.

### TECHNICAL FIELD

The present invention relates to an electronic device that can be worn on a body of a user, and more particularly to an electronic device worn on a user body and sensing a various pieces of body information of a user to provide a health care function to the user.

### BACKGROUND ART

With development of science, medical technology has also been repeatedly developed. Thus, a health care service has been provided in various fields to promote health, and developed as a medical service that prevents or administers disease by monitoring a user's biometric information, health information, etc. and provides various health care functions for directly promoting a user's health.

To monitor a user' health information, a smart health market offers various wearable devices, and an application, a platform, etc. are being developed for analyzing collected information.

### DISCLOSURE

### Technical Problem

However, the related art has a problem of just collecting and analyzing a user's information, but not directly providing a user with a health care function for promoting health based on analysis results.

Further, the related art has a problem of providing a user with a health care function based on a control command input by the user, but not considering a user's health conditions, such as sensing a user's current state, when providing the health care function.

### Technical Solution

In accordance with one embodiment of the present invention, the present invention provides an electronic device to be worn on a user's body, sensing and transmitting a user's body information to the outside, and providing a health care function to a user in response to a control signal received from the outside; a method of controlling the same; and a display device displaying a user's health conditions by receiving a user's body information from the electronic device, and transmitting the control signal for controlling the electronic device worn on the user body by receiving a control command from a user.

An object of the present invention may be achieved by providing an electronic device to be worn on a user body, the electronic device comprising: a sensor configured to sense the user body and generate body condition information; an operation implementator configured to perform a health care operation having one state among a plurality of operation states; a communicator configured to communicate with an external device; and a controller configured to: control the operation implementator to perform a health care operation of one state among the plurality of operation states with regard to the user body, control the communicator to transmit the body condition information and information about the operation state of the operation implementator to the external device, and control the operation implementator to perform the health care operation of the operation state corresponding to user control information received from the external device through the communicator among the plurality of operation states of the operation implementator.

The body condition information may comprise information about at least one of temperature and humidity of the user body, thereby sensing various parameters of a user body and achieving more accurate sensing.

The operation implementator may comprise at least one among a temperature adjuster, a humidity adjuster and a massage unit, thereby providing various health care functions to a user.

The massage unit may comprise a plurality of projections which are arranged corresponding to a certain part of the user body and capable of selectively protruding, and the operation state may comprise at least one of protruding state and extent of each of the plurality of projections, thereby proposing detailed elements of the massage unit for providing the massage function to a certain part of the user body.

The massage unit may comprise a driver configured to supply fluid so that the plurality of projections can be varied in the producing state; and a gate configured to selectively prevent the fluid from flowing in the driver corresponding to each of the plurality of projections based on the user control information, thereby providing the massage function to a user in accordance with the supply of the fluid and the block of the gate.

The massage unit may comprise a driver configured to supply an electrorheological fluid (ER) fluid to the plurality of projections, and apply an electric field to a projection to protrude among the plurality of projections, thereby providing the massage unit using the electric field.

The massage unit may comprise a driver configured to supply a magnetorheological fluid (MR) fluid to the plurality of projections, and apply a magnetic field to a projection to protrude among the plurality of projections, thereby providing the massage unit using the magnetic field.

Another object of the present invention may be achieved by providing a method of controlling an electronic device to be worn on a user body, the method comprising: sensing the user body and generating body condition information; performing a health care operation having one state among a plurality of operation states; transmitting the body condition information and information about the operation state to an external device; receiving user control information from the external device; and perform a health care operation of an operation state corresponding to the received user control information.

The body condition information may comprise information about at least one of temperature and humidity of the user body, thereby sensing various parameters of a user body and achieving more accurate sensing.

The performing of the health care operation may comprise at least one among adjusting temperature, adjusting humidity and providing a massage to the user body, thereby providing various health care functions to a user.

The providing of the massage may comprise making at least one among a plurality of projections, which are arranged corresponding to a certain part of the user body and capable of selectively protruding, protrude, thereby proposing detailed steps for providing the massage function to a certain part of the user body.

The making of at least one among the plurality of projections protrude may comprise: supplying fluid so that the plurality of projections can be varied in a protruding state; and selectively preventing the fluid from flowing, thereby supplying the fluid and selectively preventing the fluid from flowing to provide the massage function to a user.

The making of at least one among the plurality of projections protrude may comprise: supplying an electrorheological fluid to the plurality of projections; and applying an electric field to a projection to protrude among the plurality of projections, thereby using the electric field to provide the massage function to a user.

The making of at least one among the plurality of projections protrude may comprise: supplying a magnetorheological fluid to the plurality of projections; and applying a magnetic field to a projection to protrude among the plurality of projections, thereby using the magnetic field to provide the massage function to a user.

Still another object of the present invention may be achieved by providing a display device comprising: a display; a storage configured to store reference health information; a communicator configured to communicate with an external device which is worn on a user body, senses body condition information, and performs health care operation having one state among a plurality of operation states with regard to the user body; and a controller configured to determine a user's health conditions based on the body condition information received through the communicator, the operation state information of the external device, and the reference health information stored in the storage, control the display to display the determined health conditions, and control the communicator to generate user control information based on the determined health conditions and transmit the user control information to the external device.

The body condition information may include information about at least one of temperature and humidity of the user body, thereby analyzing various parameters of the user body and analyzing the health conditions more accurately.

The display device may include a user command input, and the controller may control the communicator to generate and transmit user control information to the external device based on input control command, thereby providing the health care function as desired by a user.

The controller generates information about a plurality of recommended operations based on the body condition information and the operation state information, and controls the display to display the generated recommended operation information, thereby improving convenience since the health care function is recommended based on a user's health conditions.

The user control information may include information for controlling at least one among a part, strength, speed, time, and the kind of operations of the health care operation to be performed by the external device, thereby controlling the operations of the electronic device in detail based on various parameters.

The kind of operation may include at least one among temperature adjustment, humidity adjustment, and massage function providing, thereby providing various kinds of health care functions to a user.

### Advantageous Effects

As described above, according to the present invention, a user's body information is sensed, and a user is provided with a health care function based on the sensed information.

### DESCRIPTION OF DRAWINGS

FIG. 1 illustrates a health care system according to one embodiment of the present invention.

FIG. 2 is a block diagram of an electronic device according to one embodiment of the present invention.

FIG. 3 illustrates an electronic device according to one embodiment of the present invention.

FIG. 4 illustrates an operation implementator according to one embodiment of the present invention.

FIG. 5 illustrates an operation implementator according to one embodiment of the present invention.

FIG. 6 is an enlarged view of an operation implementator according to one embodiment of the present invention.

FIG. 7 illustrates an operation implementator according to another embodiment of the present invention.

FIG. 8 illustrates an operation implementator according to another embodiment of the present invention.

FIG. 9 illustrates an operation implementator according to another embodiment of the present invention.

FIG. 10 illustrates a display device according to one embodiment of the present invention.

FIG. 11 is a block diagram of a display device according to one embodiment of the present invention.

FIG. 12 illustrates a display device according to one embodiment of the present invention.

FIG. 13 illustrates a display device according to one embodiment of the present invention.

FIG. 14 illustrates a display device according to one embodiment of the present invention.

FIG. 15 illustrates a display device according to one embodiment of the present invention.

FIG. 16 is a flowchart of a control method of an electronic device according to one embodiment of the present invention.

### BEST MODE

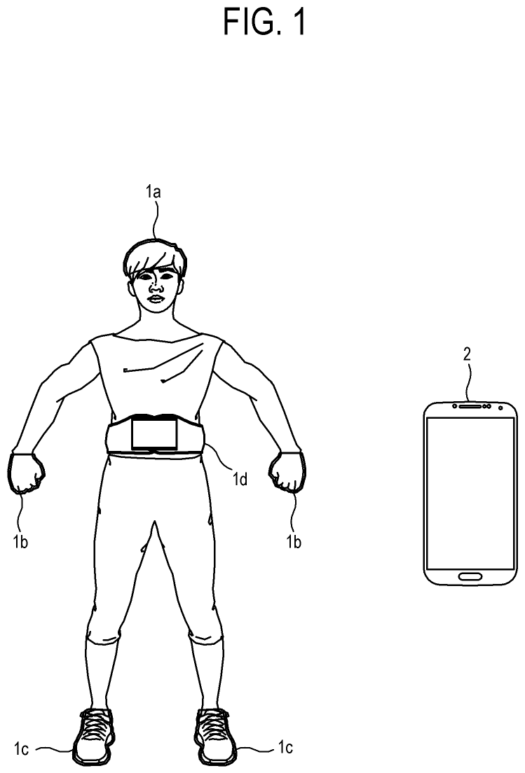

FIG. 1 illustrates a health care system according to one embodiment of the present invention. The health care system includes an electronic device 1 that can be worn on a user body, and a display device 2 that receives and analyzes a user's body information and provides information about the analyzed health conditions to the user.

As shown therein, the electronic devices 1 may be worn on a user's head, hand, foot, stomach, etc. Each electronic device 1 is capable of sensing temperature, humidity, vibration, applied pressure, etc. and transmitting sense results to the display device 2.

The display device 2 may analyze a user's health conditions based on information received from the electronic device 1, and provide the analysis results to the user. The user may read the displayed health conditions, and control a specific device to provide a desired health care function.

In this embodiment, the electronic device 1 and the display device 2 are not limited to those in the accompanying drawings and the foregoing descriptions. The electronic device 1 may be variously materialized and worn on a user's body, and the functions of the display device 2 may be achieved by an application or the like software.

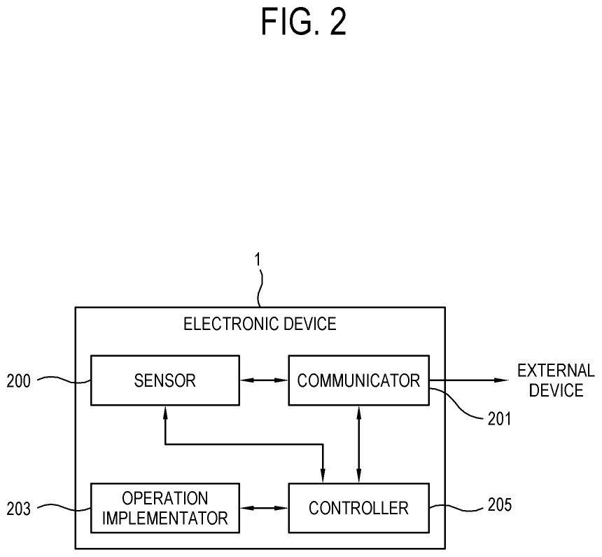

FIG. 2 is a block diagram of an electronic device according to one embodiment of the present invention. The electronic device 1 senses a user's body condition information, transmits the sense results to the display device 2, and adjusts a health care operation performed based on user control information. To this end, the electronic device 1 according to one embodiment of the present invention may include a sensor 200, a communicator 201, an operation implementator 203 and a controller 205.

The sensor 200 is configured to sense a user body and generate body condition information. The body condition information includes the temperature, the humidity, the vibration and the applied pressure of the user body, and the sensor 200 may include various kinds of sensor such as a temperature sensor, a humidity sensor, an acceleration sensor, a gyro sensor, a pressure sensor, etc.

The communicator 201 is configured to communicate with the display device 2 directly or via a network or the like, so as to transmit the sensed body condition information and the operation state information of the electronic device 1 to the display device 2. The communicator 201 may include a plurality of connection ports complying with various standards such as a high definition multimedia interface (HDMI), a universal serial bus (USB), etc. The communicator 201 may perform wired communication with a plurality of servers through a local area network (LAN). The communication performed by the communicator 201 may include wireless communication, and the communicator 201 may include a radio frequency (RF) circuit to transmit and receive an RF signal for the wireless communication. The communicator 201 may perform the wireless communication through the wireless network such as a wireless LAN, wireless fidelity (Wi-Fi), etc. Besides, the communicator 201 may perform the wireless communication with an external device or a network through Bluetooth or the like.

The operation implementator 203 is configured to provide a health care function to a user. In more detail, the operation implementator 203 may include a temperature adjuster, a humidity adjuster and a massage unit to provide various functions for adjusting temperature and humidity of a user body, massaging the user body, etc.

The controller 205 is configured to control general operations of the electronic device 1. In more detail, the controller 205 controls the operation implementator 203 to provide the health care function to a user; controls the communicator 201 to transmit the body condition information generated in the sensor 200 and the operation state information of the operation implementator 203 to the display device 2; and adjusts the operation state of the operation implementator 203 based on the user control information received through the communicator 201.

Below, for convenience of description, it will be illustrated and described that the electronic device 1 in this specification is worn on a user's foot and provides the health care function to a user, but the scope of the present invention is not limited thereto. As described above, the electronic device 1 may be worn on various body parts of a user and configured to sense a body and provide the health care function.

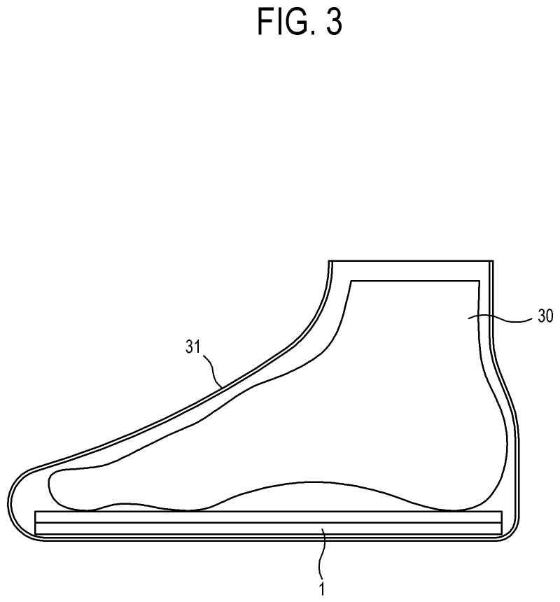

FIG. 3 illustrates an electronic device 1 according to one embodiment of the present invention. The electronic device 1 may be mounted to a shoe 30 of a user, and configured to sense the body condition information about foot 31 of the user and provide the health care function to the foot 31 of the user.

In this embodiment, the electronic device 1 is placed in a lower portion of the shoe 30 with which a user's foot 31 is in contact, but not limited thereto. The electronic device 1 may be materialized in various types as long as it is capable of sensing the body condition information of a part of a user body and providing the health care function.

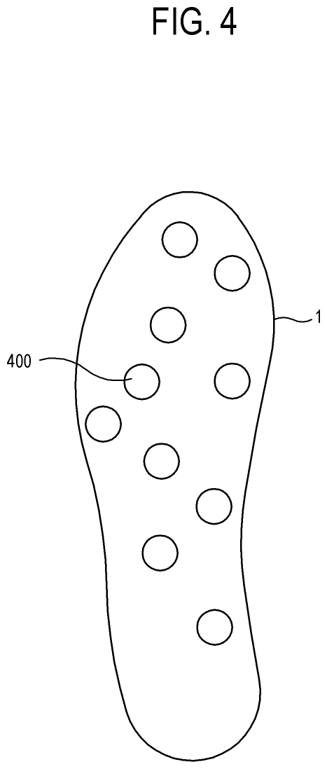

FIG. 4 illustrates an example of the electronic device and an operation implementator 203 according to one embodiment of the present invention.

The operation implementator 203 may be configured to provide the massage function as described above. To provide the massage function, the operation implementator 203 may include the massage unit, and the massage unit is arranged corresponding to a certain part of a user's body and includes a plurality of projections 400 of which protrusion is selectively achieved.

When a user walks while the plurality of projections 400 selectively protrudes, a massage function is provided so that a part of the foot corresponding to the protruding projection 400 gets acupressure. The projection 400 to protrude may be selected in response to a control command input by a user through the display device 2 or a control signal given to the electronic device 1 based on the body condition information received in the display device 2 from the electronic device 1.

The electronic device 1 makes some projections 400 protrude based on the received control signal and provides the massage function to a user's foot.

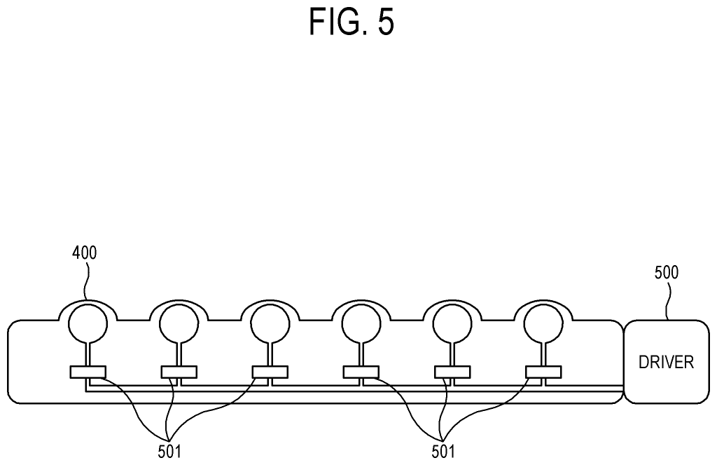

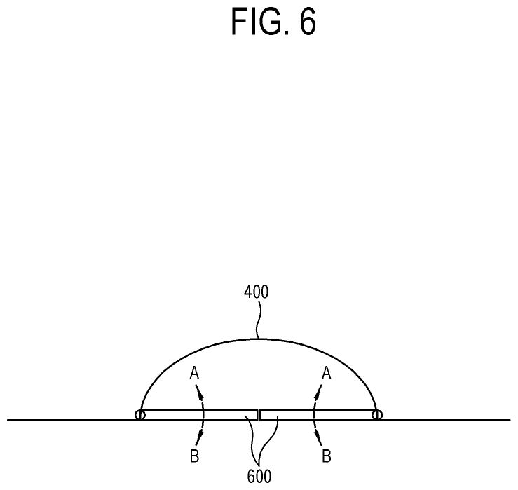

FIGS. 5 and 6 illustrate a principle of operating the massage unit as one example of the operation implementator 203 in the electronic device 1 according to one embodiment of the present invention.

Referring to FIG. 5, the operation implementator 203 according to one embodiment of the present invention may include the massage unit for providing the massage function to a user's foot, and the massage unit may include the plurality of projections 400, a driver 500 and a gate 501.

As shown therein, when a sole of a foot gets acupressure from the plurality of projections 400, there is an effect that pulled or stiffened muscles are relaxed to or kept in a normal state. Further, a stimulus applied to the sole of the foot produces a reflex action in a body and adjusts a condition of the body, and it is thus expected that blood circulation increases body temperature to thereby strengthen immunity.

The plurality of projections 400 is configured to selectively protrude and provide acupressure to a user's foot, thereby having the massage function. The driver 500 is configured to provide a fluid so that the plurality of projections 400 can protrude. The gate 501 is placed in each of the plurality of projections 400, and configured to selectively prevent the fluid from flowing.

When the driver 500 supplies the fluid to the projection 400 selected to protrude, the projection 400 protrudes and provides acupressure to a user's foot. Then, the gate 501 prevents the fluid from flowing so that the projection 400 selected to protrude can remain protruding. While the projection 400 is maintained in a protruding state, a user's foot gets acupressure with every step, thereby using the massage function.

The driver 500 may include a pump for supplying the fluid to each projection 400 in accordance with pressure applied to a heel while a user walks, and a fluid channel.

FIG. 6 is an enlarged view of the projection 400 and the gate 501. The gate 501 includes a pair of stoppers 600. The gate 501 corresponding to the projection 400 selected not to protrude restrains and holds each stopper so as to prevent the fluid from flowing into the projection 400, and the gate 501 corresponding to the projection 400 selected to protrude controls the stopper 600 to freely move in the direction of A so that the fluid can flow into the projection 400 at an inflow of the fluid but not to move in the direction of B beyond an engaging point between the stoppers 600 so that the fluid cannot flow out from the projection 400 at an outflow of the fluid. Thus, the fluid introduced into the projection 400 selected to protrude does not flow out of the projection 400, so that a user's foot can get acupressure.

The massage unit including the driver 500, the projection 400 and the gate 501 in this embodiment is merely one embodiment for materializing the present invention, and is not construed as limiting the scope of the present invention. The massage unit of the present invention may be materialized in various embodiments for providing the massage function to a user's foot.

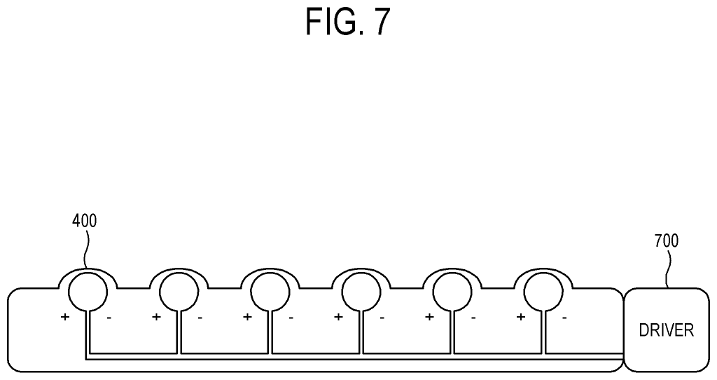

FIG. 7 illustrates a principle of operating the massage unit as one example of the operation implementator 203 in the electronic device 1 according to another embodiment of the present invention.

The massage unit according to another embodiment of the present invention may be configured to use an electrorheological (ER) fluid which is solidified under an electric field, or a magnetorheological fluid (MR) fluid which is solidified under a magnetic field, instead of water or the like fluid of which state is not varied. A driver 700 may be configured to supply the electrorheological fluid or the magnetorheological fluid to the projection 400 selected to protrude, and apply the electric field or the magnetic field. As the electric field or the magnetic field is applied, the supplied fluid is solidified to thereby provide the massage function to a user's foot.

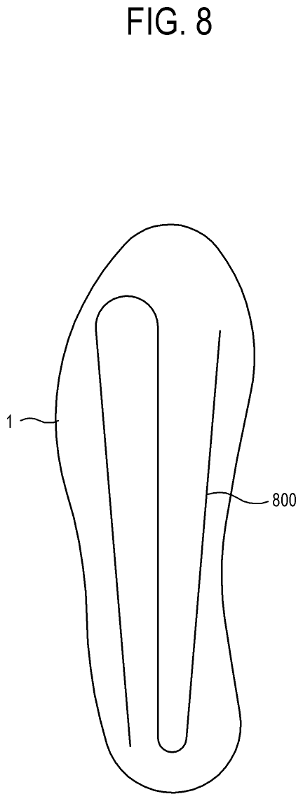

FIG. 8 illustrates a temperature adjuster as one example of the operation implementator 203 in the electronic device 1 according to still another embodiment of the present invention.

The operation implementator 203 according to this embodiment of the present invention may include a temperature adjuster 800 for adjusting temperature of a part of a user body temperature. The temperature adjuster 800 in this embodiment is configured to turn up or down a temperature under control of the controller 205.

Referring to FIG. 8, the temperature adjuster 800 may include a hot wire or the like placed in a shoe and directly providing heat with applied electricity. However, the temperature adjuster 800 is not limited to that in the accompanying drawing and the foregoing descriptions. Alternatively, the temperature adjuster may be materialized in various forms as long as it can allow a user to adjust the temperature of his/her body part wearing the electronic device 1.

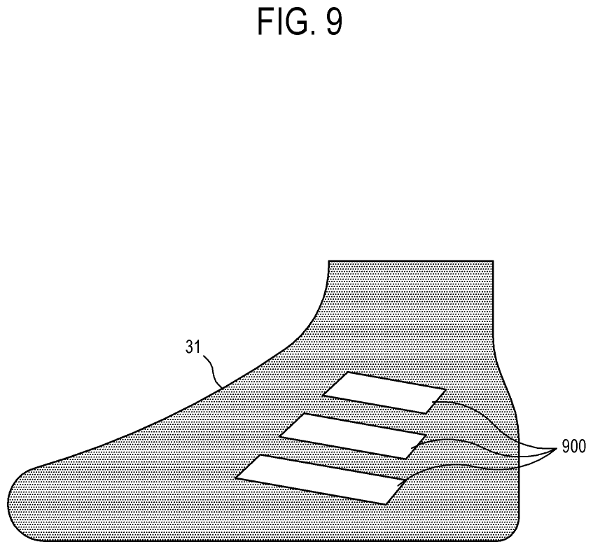

FIG. 9 illustrates an example of an operation implementator 203 in the electronic device 1 according to still another embodiment of the present invention.

The operation implementator 203 according to this embodiment of the present invention may include a humidity adjuster 900 for adjusting humidity of a part of a user body. The humidity adjuster 900 in this embodiment is configured to increase or decrease temperature under control of the controller 205.

Referring to FIG. 9, the humidity adjuster 900 may be configured to open a part of the shoe so that moisture can be naturally removed. However, the humidity adjuster 900 is not limited to that in the accompanying drawing and the foregoing descriptions. Alternatively, the humidity adjuster may be materialized in various forms as long as it can allow a user to adjust the humidity of his/her body part wearing the electronic device 1.

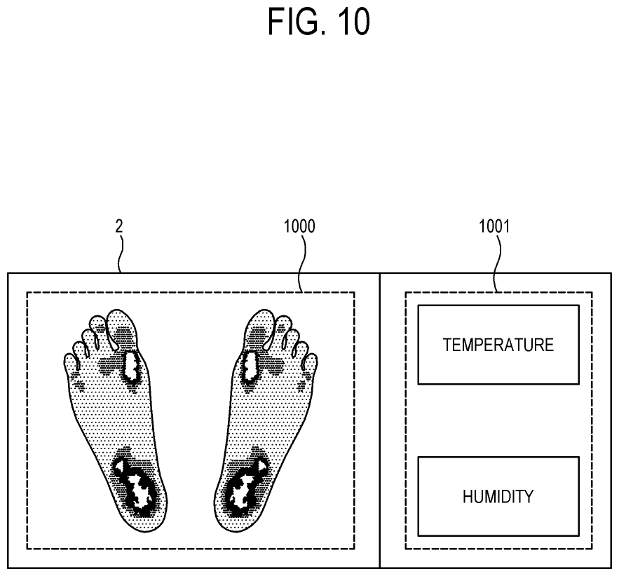

FIG. 10 illustrates an example of a display device 2 according to one embodiment of the present invention.

The display device 2 may receive body condition information sensed by the sensor 200 of the electronic device 1 and operation state information of the electronic device 1 from the electronic device 1. The body condition information may include information about temperature, humidity, applied pressure or the like of a part of a user who wears the electronic device 1, and the operation state information of the electronic device 1 may include information about whether the health care function of the electronic device 1 is turned on or off, where the function is applied, or how strong the function is. The display device 2 may be configured to analyze a user's current health conditions by comparing the received body condition information and operation state information with the previously stored reference health information, and display the analysis results through a display.

The display device 2 may be configured to display a user interface (UI) which includes an item 1000 corresponding to a part of a user body, and a menu item 1001 for allowing a user to select desired information, and a user may select the menu item so that the display device can display a distribution of temperature or humidity corresponding to a body part.

Further, a user may input a control command to the display device 2 so as to select the kind of health care function, a body part to be subjected to the health care function, the strength of the health care function, etc. to thereby promote health, based on the displayed health conditions.

In response to the command input by a user, the display device 2 transmits a control signal to the electronic device 1 worn on a user so that the electronic device 1 can provide the user with the health care function based on the control signal.

According to the accompanying drawing, a user's foot 1000 is displayed on the display, and a user selects the menu item 1001 so that the display device 2 can display the temperature or humidity of the foot.

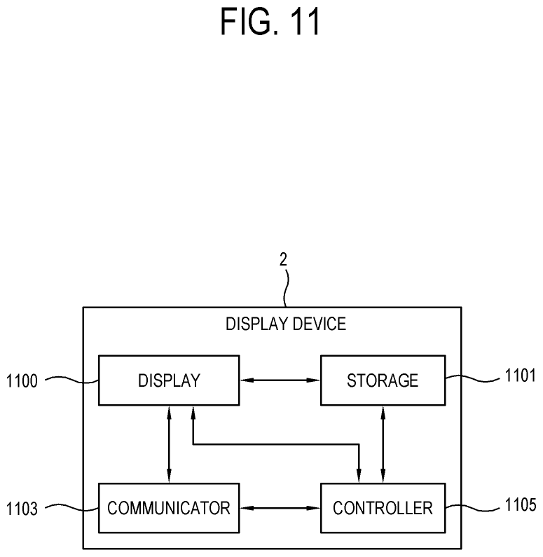

FIG. 11 is a block diagram of a display device 2 according to one embodiment of the present invention.

According to one embodiment of the present invention, the display device 2 receives sensed information, analyzes health conditions of a user based on the received information, and transmits a control command of the user to an electronic device 1 worn on the user.

Referring to FIG. 11, the display device 2 includes a display 1100, a storage 1101, a communicator 1103 and a controller 1105.

The display 1100 is configured to display an image based on a received signal, and is achieved by various types such as a liquid crystal display (LCD), a plasma display panel (PDP), an organic light emitting diode (OLED), etc. to display the image.

The storage 1101 is configured to store various pieces of information under control of the controller 1105. The storage 1101 may be materialized by a nonvolatile memory such as a flash memory, a hard disk drive, etc. The data stored in the storage 1101 may for example include reference health information mapped to the sensed body condition information received from the electronic device 1, and various applications for executing the function of the display device 2 such as an operating system (OS) for operating the display device 2.

The communicator 1103 is configured to receive the sensed body condition information and the operation state information from the electronic device 1, and perform direct or indirect communication with the electronic device 1 to provide user's control information to the electronic device 1. The communicator 1103 may include connection ports complying with various standards for directly connecting with the electronic device 1, or a communication module connected to a wired or wireless network for communicating with the electronic device 1.

The display device 2 may further include a user command input for receiving a user's command. To control the display device 2 or control the wearing electronic device 1 through the display device 2, a user may input the control command through the user command input. The display device 2 may be controlled in response to the control command input through the user command input, so that the control signal can be generated and transmitted to the electronic device 1. The user command input may be configured to receive a control signal remotely through a remote controller, or receive a control signal directly through a lower panel or the like of the display device 2. Further, the display 1100 may be materialized by a touch screen for receiving a user's touch input, motion, gesture, etc. and include the user command input.

The controller 1105 is configured to control general operations of the display device 2. In more detail, the controller 1105 in this embodiment is configured to determine a user's health conditions based on information received from the electronic device 1 through the communicator 1103, display the determined user health conditions on the display 1100, and control the electronic device 1 worn on the user in response to the control command input by the user.

Further, the controller 1105 may be configured to provide a user with recommended information about an applied part, strength, time and the like of the health care function based on health conditions of the user. For example, when it is sensed that temperature is rapidly dropped at a user's specific body part, the controller 1105 may control the display 1100 to display a massage function or an item recommended to a user for increasing the temperature at the corresponding body part so that a user's health can be promoted by a massage or temperature adjustment.

A user just approves of the health care function recommended by the display device 2 so that a control command signal can be transmitted to or a desired part, strength and time are set to the electronic device 1, thereby making an input for the health care function to the display device.

According to another embodiment, the function to be provided by the display device 2 may be achieved by an application or the like software or firmware previously installed in the display device 2. For example, the display device 2 may be materialized by a mobile phone, a personal computer, a TV, etc. The display device 2 may be configured to perform the functions of the present invention through the application downloaded through App store or the like. That is, the present invention may be embodied by the application or program including a step of controlling the communicator 1103 of the display device 2 to receive the sensed body condition information and the operation state information of the electronic device 1 from the electronic device 1, a step of analyzing a user's health conditions based on the received body condition information and the previously stored reference health information, and a step of displaying the analyzed user health conditions and controlling the communicator 1103 of the display device 2 to transmit a control signal to the electronic device 1 based on a control command received from a user.

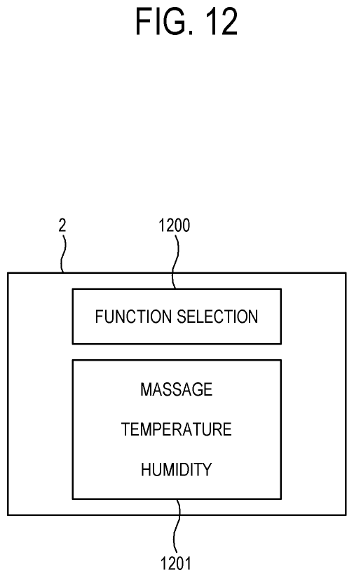

FIG. 12 illustrates an example of a display device 2 according to one embodiment of the present invention.

The display device 2 may be configured to provide a user interface (UI) with menu items corresponding to functions so that a user can select the health care function.

As described above, the electronic device 1 may adjust the temperature or humidity of the portion thereof worn on a user or provide the massage function, and the display device 2 may be configured to make the display 1100 display a UI with a function selection guide 1200 and menu items 1201 respectively corresponding to the functions so that a user can select a desired function through the user command input.

The accompanying drawing and descriptions of this embodiment is merely an example, and thus the display device 2 may be configured to display a UI variously achieved for allowing a user to select a function.

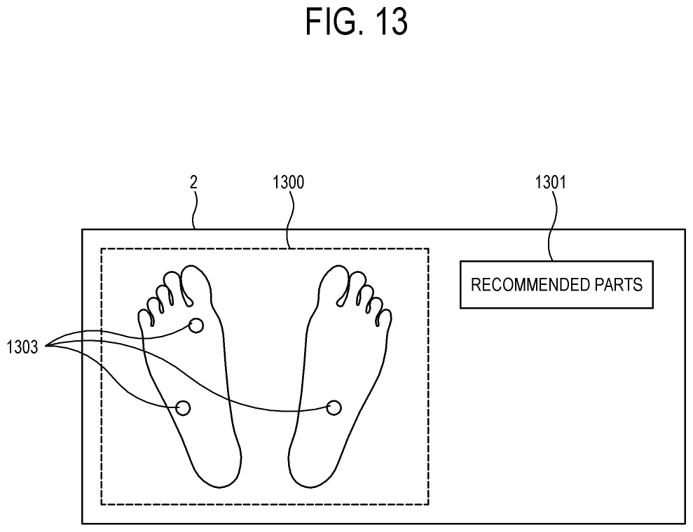

FIG. 13 illustrates an example of the display device 2 according to one embodiment of the present invention.

The display device 2 may recommend a part, to which the health care function will be applied, based on a user's health conditions. The display device 2 may be configured to make the display 1100 display a UI with a guide 1301 for informing that a specific part is recommended, an item 1300 corresponding to a user body, and an item 1303 corresponding to the recommended part of the user body to which the health care function is applied based on the user health conditions.

The recommendation may be based on a user's health conditions. For instance, when it is determined based on the information received from the electronic device 1 that temperature is rapidly dropped at a certain part of a user body, the display device 2 may recommend the user to use the massage function at the certain part so that blood circulation can be promoted in the certain part.

In response to selection or simple approve of the displayed area, the electronic device 1 may be configured to control the projection 400 to protrude corresponding to the recommended part and provide the massage function to a user.

The accompanying drawing and descriptions in this embodiment are merely given as an example, and thus there may be various embodiments of the display device 2 for showing a user a user interface related to the health care function. In more detail, the display device 2 may make a recommendation about the applied strength, time, etc. of the health care function as well as the recommendation about a certain part of the body to which the health care function will be applied, and a user can simply approve of or directly set the health care function based on the recommended information and thus receives the health care function.

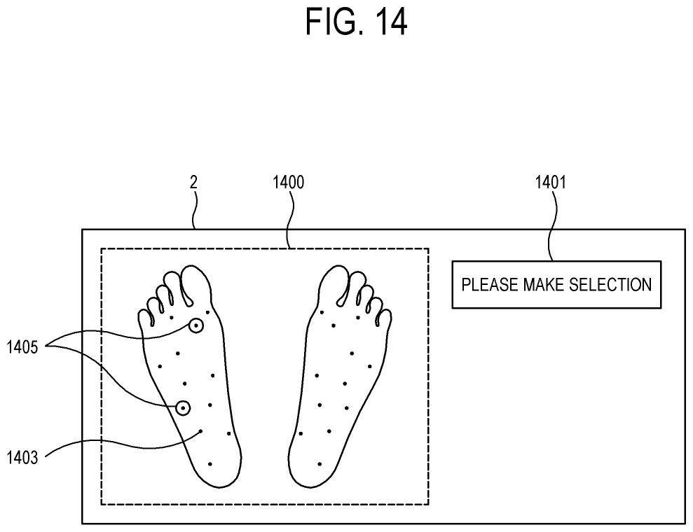

FIG. 14 illustrates an example of the display device 2 according to one embodiment of the present invention.

As described above, the display device 2 may be configured to provide sensed body condition information to a user so that the user can select a certain part of his/her body, and thus transmit user control information to the electronic device 1 so that the health care function can be provided to the part selected by the user.

A user may input a control command to the display device 2 so that the health care function can be applied to the recommended body part or the health care function can be provided to a liking part even though the liking part is not recommended.

The display device 2 may be configured to make the display 1100 display a guide 1401 for informing that a body part to be subjected to the health care function needs to be selected, an item 1400 corresponding to a user body, an item 1403 selectable by a user, and a UI including the item 1405 selected by the user.

The input of the control command for providing the health care function to a body part desired by a user is not limited to that of this embodiment. According to another embodiment, the display device 2 may be configured to display a UI through which a user can adjust the health care function in various ways, e.g. adjust the strength by which the health care function will be applied, the time for which the health care function will be applied, etc.

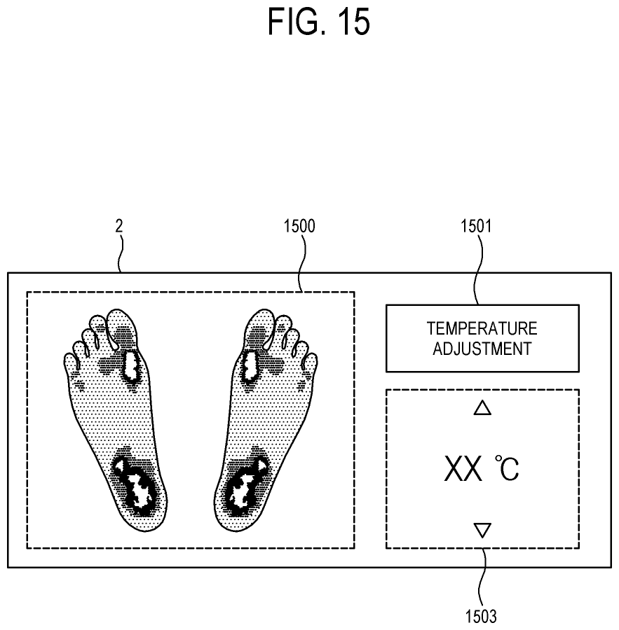

FIG. 15 illustrates an example of the display device 2 according to another embodiment of the present invention.

The display device 2 may be configured to display various user interfaces so that a user can control the health care function. In this embodiment, the display device 2 may be configured to display a guide 1501 for informing a user that temperature will be adjusted, an item 1500 corresponding to a user body, and a temperature adjusting item 1503 for allowing a user to adjust the temperature.

When it is determined that a certain part of a user body has a low or high temperature, a user may adjust the temperature based on the body condition information of the user body through the UI.

According to another embodiment, the display device 2 may be configured to display the UI so that a user can adjust humidity at a certain part of the body.

Although the accompanying drawing and the foregoing descriptions illustrate that the display device 2 adjusts the temperature and humidity of the foot, the display device 2 is not limited thereto. Alternatively, the display device may be achieved to adjust the temperature and humidity of various body parts on which a user wears the electronic device 1.

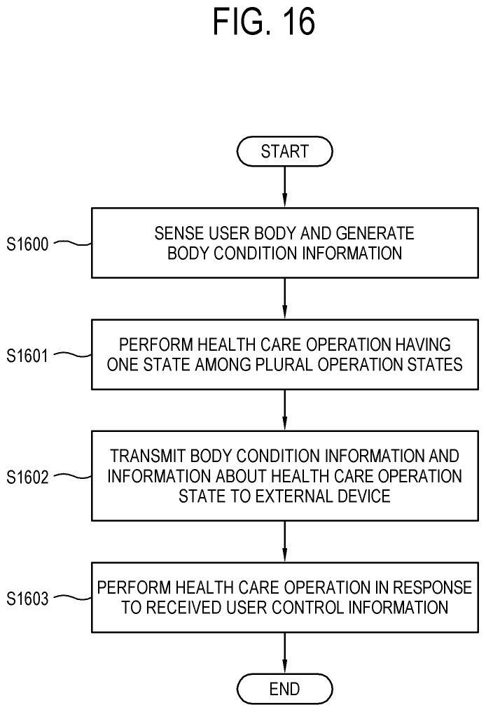

FIG. 16 is a flowchart of a control method of an electronic device according to one embodiment of the present invention.

First, at operation S1600, the sensor 200 senses a user body and generates body condition information. Then, at operation S1601, the controller 205 controls the operation implementator 203 to perform a health care operation as one state among a plurality of operation states. Then, at operation S1602, the controller 205 controls the communicator 201 to transmit the body condition information and the state information of the health care operation to an external device. Last, at operation S1503, the controller 205 controls the operation implementator 203 to perform the health care operation in response to user's control information received through the communicator 201.

As described above, the present invention is not limited to the display device 2 and the control method thereof, and may be materialized by a storage medium of storing a program for implementing the foregoing operations.

1. An electronic device to be worn on a user body, the electronic device comprising:
a sensor configured to sense the user body and generate body condition information;
an operation implementator configured to perform a health care operation having one state among a plurality of operation states;
a communicator configured to communicate with an external device; and
a controller configured to:
control the operation implementator to perform a health care operation of one state among the plurality of operation states with regard to the user body,
control the communicator to transmit the body condition information and information about the operation state of the operation implementator to the external device, and
control the operation implementator to perform the health care operation of the operation state corresponding to user control information received from the external device through the communicator among the plurality of operation states of the operation implementator.

2. The electronic device according to claim 1, wherein the body condition information comprises information about at least one of temperature and humidity of the user body.

3. The electronic device according to claim 1, wherein the operation implementator comprises at least one among a temperature adjuster, a humidity adjuster and a massage unit.

4. The electronic device according to claim 3, wherein
the massage unit comprises a plurality of projections which are arranged corresponding to a certain part of the user body and capable of selectively protruding, and
the operation state comprises at least one of protruding state and extent of each of the plurality of projections.

5. The electronic device according to claim 4, wherein the massage unit comprises a driver configured to supply fluid so that the plurality of projections can be varied in the producing state; and a gate configured to selectively prevent the fluid from flowing in the driver corresponding to each of the plurality of projections based on the user control information.

6. The electronic device according to claim 4, wherein the massage unit comprises a driver configured to supply an electrorheological fluid (ER) fluid to the plurality of projections, and apply an electric field to a projection to protrude among the plurality of projections.

7. The electronic device according to claim 4, wherein the massage unit comprises a driver configured to supply a magnetorheological fluid (MR) fluid to the plurality of projections, and apply a magnetic field to a projection to protrude among the plurality of projections.

8. A method of controlling an electronic device to be worn on a user body, the method comprising:
sensing the user body and generating body condition information;
performing a health care operation having one state among a plurality of operation states;
transmitting the body condition information and information about the operation state to the external device;
receiving user control information from the external device; and
perform a health care operation of an operation state corresponding to the received user control information.

9. The method according to claim 8, wherein the body condition information comprises information about at least one of temperature and humidity of the user body.

10. The method according to claim 8, wherein the performing of the health care operation comprises at least one among adjusting temperature, adjusting humidity and providing a massage to the user body.

11. The method according to claim 10, wherein the providing of the massage comprises making at least one among a plurality of projections, which are arranged corresponding to a certain part of the user body and capable of selectively protruding, protrude.

12. The method according to claim 11, wherein the making of at least one among the plurality of projections protrude comprises:
supplying fluid so that the plurality of projections can be varied in a protruding state; and
selectively preventing the fluid from flowing.

13. The method according to claim 11, wherein the making of at least one among the plurality of projections protrude comprises:
supplying an electrorheological fluid to the plurality of projections; and
applying an electric field to a projection to protrude among the plurality of projections.

14. The method according to claim 11, wherein the making of at least one among the plurality of projections protrude comprises:
supplying a magnetorheological fluid to the plurality of projections; and
applying a magnetic field to a projection to protrude among the plurality of projections.

15. A display device comprising:
a display;
a storage configured to store reference health information;
a communicator configured to communicate with an external device which is worn on a user body, senses body condition information, and performs health care operation having one state among a plurality of operation states with regard to the user body; and
a controller configured to determine a user's health conditions based on the body condition information received through the communicator, the operation state information of the external device, and the reference health information stored in the storage, control the display to display the determined health conditions, and control the communicator to generate user control information based on the determined health conditions and transmit the user control information to the external device.
